(19) United States
(12) Patent Application Publication
(10) Pub. No.: US 2013/0188550 A1
(43) Pub. Date: Jul. 25, 2013

(54) DEVICE AND METHOD FOR ALLOCATING RADIO RESOURCES IN WIRELESS COMMUNICATION NETWORK

(71) Applicants: Tae Gyun Noh, Daejeon (KR); Jae Young Ahn, Daejeon (KR); Jae Heung Kim, Daejeon (KR)

(72) Inventors: Tae Gyun Noh, Daejeon (KR); Jae Young Ahn, Daejeon (KR); Jae Heung Kim, Daejeon (KR)

(73) Assignee: ELECTRONICS AND TELECOMMUNICATIONS RESEARCH INSTITUTE, Daejeon (KR)

(21) Appl. No.: 13/877,379

(22) PCT Filed: Sep. 27, 2011
(86) PCT No.: PCT/KR2011/007071

§ 371 Date: Apr. 2, 2013

(30) Foreign Application Priority Data
Oct. 4, 2010 (KR) 10-2010-0096563
Sep. 26, 2011 (KR) 10-2011-0096821

(51) Int. Cl. H04W 72/04

(52) U.S. Cl. CPC H04W 72/0446
USPC 370/312; 370/336

(57) ABSTRACT

Disclosed is a method for allocating radio resources in a wireless communication system. Subframes that use only a particular terminal or a particular terminal group are allocated through the period, offset, and number of subframes that are consecutively used, or the subframes are allocated through the period, offset, and bitmap for subframes that are available within one or a plurality of frames, whereby radio resources are effectively allocated.

### TECHNICAL FIELD

The present invention relates to an apparatus for allocating radio resources in a wireless communication network and a method thereof, and more particularly, to an apparatus for allocating radio resources to at least one terminal in a wireless communication network in which the radio resources use a frame structure divided in terms of time and having a certain period, and a method thereof.

### BACKGROUND ART

Mobile communication technology developed by the Third Generation Partnership Project (3GPP) has been widely used by most people in the world. Recently, technology studied and developed by the 3GPP includes evolved wireless access technology known as Long Term Evolution (LTE), and technology related to an evolved packet core network (system architecture evolution), which is associated with the evolved wireless access technology.

An LTE downlink transmission scheme is based on orthogonal frequency division multiplexing (OFDM). In an uplink, a single-carrier transmission scheme based on discrete Fourier transform spread (DFTS)-OFDM is used. Further, processing for LTE includes different protocol layer architecture. In LTE protocol architecture, for example, in the case of downlink, data to be transmitted enters a processing procedure in the form of an IP packet on an SAE bearer. In the processing procedure, the IP packets, before being transmitted via a wireless interface, are subjected to several protocol entities, such as a packet data convergence protocol (PDCP) layer that performs IP head compression, a radio link control (RLC) layer that transmits segmentation/concatenation, retransmission management and data to upper layers in order, a medium access control (MAC) layer that performs HARQ retransmission and uplink and downlink scheduling, and a physical layer (PHY) that is responsible for coding/decoding, modulation/demodulation, multiple-antenna mapping and other general physical layer functions, in order to reduce the number of bits transmitted over the wireless interface.

Among these, transmission of the LTE physical layer is performed through a time-domain structure for LTE transmission based on a frame having a certain time length. Each frame is identified by a system frame number (SFN). The SFN is used to control several transmission periods that may be longer than one frame, like a paging and sleep-mode period or a channel state report period. In the LTE, one frame consists often subframes each having a length of 1 ms and has a time length of 10 ms.

The LTE can operate both a frequency division duplex (FDD) mode and a time division duplex (TDD) mode. A frame structure is substantially similar between the FDD mode and the TDD mode but differs in some points.

It is necessary to allocate radio resources divided based on such frames according to certain criteria so that a base station and a terminal transmit and receive data. However, since one or a plurality of subframes included in one frame are allowed to be used by only a specific terminal or terminal group related to a specific service, it is difficult to allocate the radio resources.

### DISCLOSURE

### Technical Problem

The present invention is directed to an apparatus for allocating radio resources to at least one terminal in a wireless communication network in which the radio resources use a frame structure divided in terms of time and having a certain period.

The present invention is also directed to a method of allocating radio resources to at least one terminal in a wireless communication network in which the radio resources use a frame structure divided in terms of time and having a certain period.

### Technical Solution

One aspect of the present invention provides an apparatus for allocating radio resources to at least one terminal in a wireless communication network in which the radio resources use a frame structure divided in terms of time and having a certain period, the apparatus including: a control unit for recognizing information on a period, an offset, and a subframe to be used regarding radio resources allocated to a terminal group consisting of at least one terminal sharing a feature, and forming subframe allocation information for each terminal group using the information; and a wireless transmission unit for transmitting the formed subframe allocation information to the at least one terminal.

According to the apparatus for allocating radio resources of the first embodiment of the present invention, the information on the subframe to be used may include a first subframe indicated by each configuration, and the number of continuously used sub frames.

Here, the first subframe indicated by each configuration may be calculated using at least one of the number of subframes constituting one frame, a frame index, and a subframe index, and a period of the configuration.

Here, a subframe indicated by a configuration i as allocation information for each terminal group may be defined by the following equation:

(n_{ƒ}×N_{sƒ}+n_{sƒ})modT_{sƒ,i} ∈{D_{sƒ,i}, (D_{sƒ,i}+1), . . . , (D_{sƒ,i}+N_{consc,i}−1)}

where N_{sƒ} denotes the number of subframes constituting one frame, n_{ƒ}denotes a frame index, n_{sƒ} denotes a subframe index, T_{sƒ,i} denotes a period of configuration i, D_{sƒ,i} denotes an offset of configuration i, N_{consc,i} denotes the number of continuously used subframes of configuration i, and “mod” denotes a modulo operator.

According to the apparatus for allocating radio resources of the first embodiment of the present invention, the information on the subframe to be used may be bitmap information for available subframes in at least one frame in one period.

Here, the number of bits constituting the bitmap may be calculated by multiplying the number of available subframes in one frame by the number of frames indicated by the bitmap.

If the bitmaps indicate allocation information for a plurality of frames, the bitmaps may be individually and sequentially formed for respective frames.

An offset D_{f,i} of configuration i is defined as allocation information for each terminal group by the following equation:

n_{ƒ}modT_{ƒ, i}=D_{ƒ,i}

where n_{ƒ} denotes a frame index, T_{ƒ,i} denotes a period of configuration i, D_{ƒ,i} denotes an offset of configuration i, and “mod” denotes a modulo operator.

Here, the subframe allocation information may be transmitted to all terminals in a cell by broadcast using broadcast information in a radio resource control (RRC) message.

Further, the subframe allocation information may be individually transmitted to at least one terminal related to the subframe allocation information through a signaling radio bearer in a RRC message.

Another aspect of the present invention provides the present invention provides a method of allocating radio resources to at least one terminal in a wireless communication network in which the radio resources use a frame structure divided in terms of time and having a certain period, the method including: recognizing information on a period, an offset, and a subframe to be used regarding radio resources allocated to a terminal group consisting of at least one terminal sharing a feature, and forming subframe allocation information for each terminal group using the information; and transmitting the formed subframe allocation information to the at least one terminal.

Here, the terminal group consisting of at least one terminal sharing a feature may include at least one of a group of terminals that receive a nominal MBMS subframe, an LTE-Advanced terminal group, and a group of terminals that substantially receive MBMS data.

### Advantageous Effects

According to the apparatus for allocating radio resources in a wireless communication network of the present invention and the method thereof, a subframe used by only a specific terminal or terminal group is allocated through the period, the offset, and the number of continuously used subframes or through the period, the offset, and the bitmap for an available subframe in one or a plurality of frames, thereby effectively allocating radio resources.

### DESCRIPTION OF DRAWINGS

FIG. 1 illustrates a configuration of a wireless communication system to which several embodiments of the present invention are applied.

FIG. 2 is a conceptual diagram illustrating a method of allocating radio resources according to an embodiment of the present invention.

FIG. 3 is a conceptual diagram illustrating a method of allocating radio resources according to another embodiment of the present invention.

FIG. 4 is a conceptual diagram illustrating a method of allocating radio resources according to yet another embodiment of the present invention.

FIG. 5 is a flowchart of a method of allocating radio resources according to a preferred embodiment of the present invention.

### MODES OF THE INVENTION

While the invention is susceptible to various modifications and alternative forms, specific embodiments thereof are shown by way of example in the drawings and will herein be described in detail.

However, it should be understood that there is no intent to limit the invention to the particular forms disclosed, but on the contrary, the invention is to cover all modifications, equivalents, and alternatives falling within the spirit and scope of the invention

The terminology used herein is for the purpose of describing particular embodiments only and is not intended to be limiting of the invention. As used herein, the singular forms “a, ” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, configurations, and/or configurations, but do not preclude the presence or addition of one or more other features, integers, steps, operations, configurations, configurations, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined here.

Hereinafter, exemplary embodiments of the present invention will be described in detail. To facilitate understanding of the present invention, like numbers refer to like components throughout the description of the drawings, and description of the same component will not be reiterated.

In the present invention, a “base station” is used as “a control apparatus controlling one cell.” A “physical base station” in a real communication system can control a plurality of cells. In this case, the “physical base station” may be considered to include several “base stations” in the present invention. That is, a parameter differently allocated to each cell may be considered to be allocated as a different value by each “base station.”

In the present invention, a terminal may be user equipment (UE), a mobile station (MS), a relay node (RN), or a machine type communication (MTC) device.

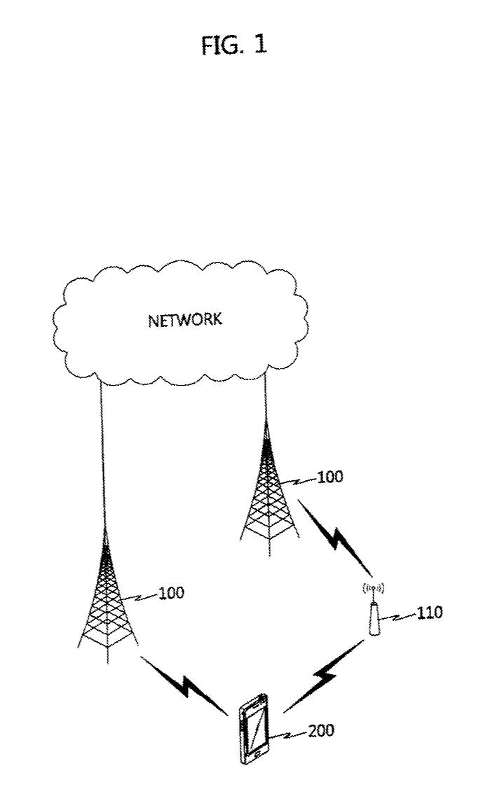

FIG. 1 illustrates a configuration of a wireless communication system to which several embodiments of the present invention are applied.

A wireless communication system to which the present invention may be applied includes at least one base station 100 connected to a network including, for example, a wired network, and at least one user terminal 200. The wireless communication system may further include, for example, a relay 110 according to a feature of a cell.

The base station 100 is a wireless end node for transmitting data to the user terminal. The wireless end node may be a small or home base station covering a certain service area, as well as a general base station. The wireless end node may be the relay 110 as shown in FIG. 1. Here, the base station or the relay may be a preferred embodiment of the apparatus for allocating radio resources according to the present invention. The base station 100 or the relay 110 distributes, i.e., allocates, radio resources to terminals controlled by the base station 100 or the relay 110 according to a certain rule in order to transmit date to the terminals.

Wireless resources transmitted or received between the base station (or the relay) and terminal may be formed in a subframe unit. One frame may include a plurality of subframes.

One or a plurality of subframes in one frame Is allowed to be used by only a specific terminal or terminal group. Here, the specific terminal group may be, in an embodiment, a terminal group using multimedia broadcast multicast service (MBMS) or an LTE-Advanced terminal group.

There may be two methods of allocating the subframe used by only the specific terminal or terminal group. Here, the subframe may be a downlink subframe or an uplink subframe.

The radio resource allocation apparatus according to an embodiment of the present invention may allocate radio resources to at least one terminal in a wireless communication network in which the radio resources use a frame structure divided in terms of time and having a certain period, and may include a control unit for recognizing information on a period, an offset, and a subframe to be used regarding radio resources allocated to a terminal group consisting of at least one terminal sharing a feature, and forming subframe allocation information for each terminal group using the information.

The formed radio resource allocation information is reported to all terminals or related specific terminals in a service area via a wireless transmission unit of each wireless end node 100 or 110. The apparatus for allocating radio resources according to an embodiment of the present invention may be the base station 100 or the relay 110.

Hereinafter, the method of allocating radio resources according to the present invention will be described in greater detail.

In the first method of allocating radio resources according to the present invention, radio resources are allocated through a period, an offset, and the number of continuously used subframes. Here, both the period and the offset are subframe units, and the offset is smaller than the period. If one configuration includes one each of a period, an offset, and the number of continuously used subframes, a method of allocating a subframe used by only a specific terminal or terminal group may be a combination of one or a plurality of configurations.

A subframe indicated by each configuration of the first method may be represented by Equation 1.

(n_{ƒ}×N_{sƒ}+n_{sƒ})modT_{sƒ,i} ∈{D_{sƒ,i}, (D_{sƒ,i}+1), . . . , (D_{sƒ,i}+N_{consc,i}−1)} Equation 1

In Equation 1, N_{sƒ} denotes the number of subframes constituting one frame, n_{ƒ} denotes a frame index, n_{sƒ} denotes a subframe index, T_{sƒ,i} denotes a period of configuration i, D_{sƒ} denotes an offset of configuration i, and N_{consc,i} denotes the number of continuously used subframes of configuration i. “mod” denotes a modulo operator.

Further, the offset D_{sƒ,i} of configuration i is set from a first subframe of a first frame. For example, the first frame may be a frame in which SFN=0. The system frame number (SFN) denotes a frame index used by the base station and the terminal.

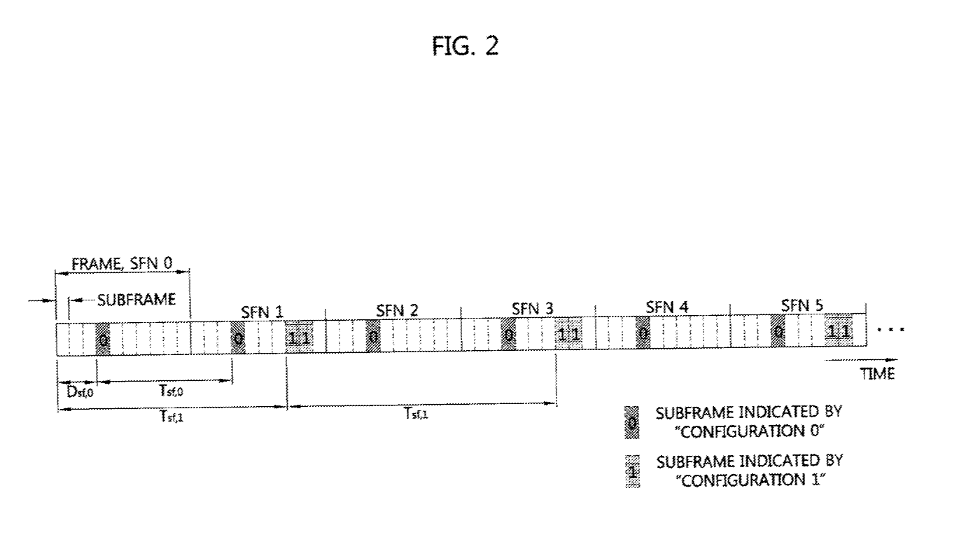

FIG. 2 is a conceptual diagram illustrating the method of allocating radio resources according to an embodiment of the present invention.

In FIG. 2, N_{sf} is assumed to be 10. FIG. 2 shows an example in which radio resources are allocated to two configurations, i.e., two terminal groups. As can be seen from FIG. 2, in a first configuration “configuration 0,” a period is 10, an offset is 3, and the number of continuously used subframes is 1. In a second configuration “configuration 1,” a period is 20, an offset is 17, and the number of continuously used subframes is 2.

In a second method of allocating radio resources according to the present invention, the radio resources are allocated through a period, an offset, and a bitmap for available subframes in one or a plurality of frames. Mere, both the period and the offset are frame units, and the offset is smaller than the period. The second method of allocating radio resources according to the present invention differs from the first method in that the period and the offset are the frame units.

In the second method of allocating radio resources according to the present invention, when a range of a bitmap for a subframe is a plurality of frames, the period is equal to or greater than the number of frames indicated by the bitmap. A bit number of the bitmap is equal to the number of available subframes in one frame multiplied by the number of frames indicated by the bitmap. When the number of frames indicated by the bitmap is more than 1, bitmaps may be individually and sequentially formed as a bitmap for a first frame, a bitmap for a second frame, etc. A bitmap for one frame is sequentially configured of available subframes in the frame. When one configuration includes one each of a period, an offset, and a bitmap for available subframes in one or a plurality of frames, the method of allocating a subframe used by only a specific terminal or terminal group may be one configuration or a combination of a plurality of configurations.

A frame indicated by each configuration of the second method may also be represented by Equation 2.

n_{ƒ}modT_{ƒ,i}=D_{ƒ,i} Equation 2

In Equation 2, n_{ƒ} denotes a frame index, T_{ƒ,i} denotes a period of configuration i, and D_{ƒ,i}, denotes an offset of configuration i. Further, the offset D_{ƒ,i} of configuration i is set with reference to a first subframe of a first frame. For example, the first frame may be a frame in which SFN=0. A n SFN is a frame index used by the base station and the terminal.

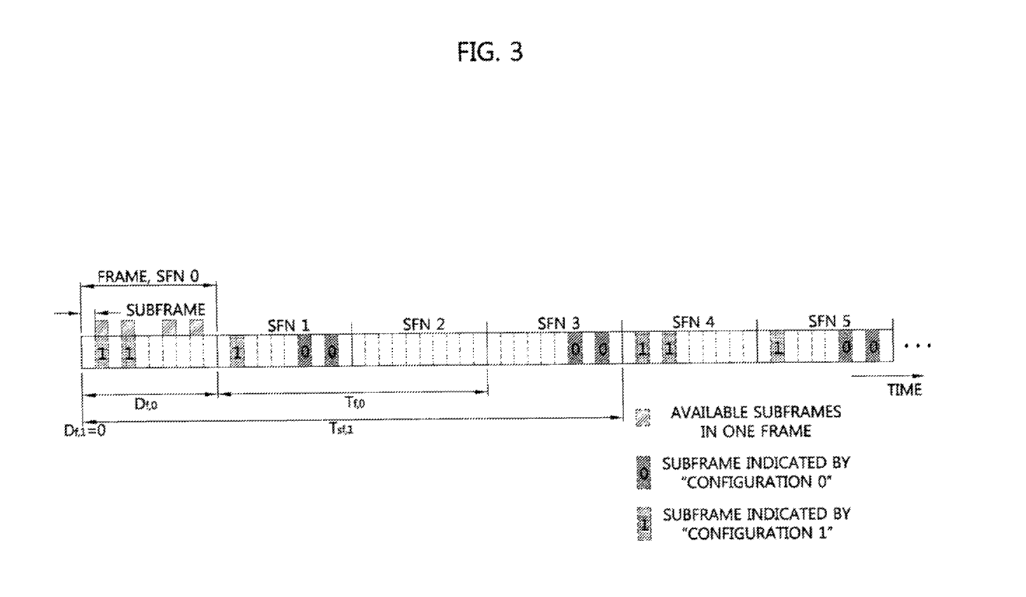

FIG. 3 is a conceptual diagram illustrating a method of allocating radio resources according to another embodiment of the present invention.

In FIG. 3, the number of subframes constituting one frame is assumed to be 10. Available subframes in one frame are assumed to be a total of four frames: a second subframe, a fourth subframe, a seventh subframe, and a ninth subframe.

FIG. 3 shows two configurations. In a first configuration “configuration 0,” a period is 2 and an offset is 1. A range of a bitmap for subframes is one frame. In this case, the bitmap consists of a total of 4 bits, and the bitmap of the “configuration 0” may be represented as 0011. Here, 1 indicates a used subframe, and 0 indicates an unused subframe.

In a second configuration “configuration 1,” the period is 4 and the offset is 0. A range of a bitmap for subframes is two frames. In this case, the bitmap consists of a total of 8 bits, and the bitmap of the “configuration 1” may be represented as 11001000. Here, 1 indicates a used subframe and 0 indicates an unused subframe.

A method of allocating a subframe used by only a specific terminal or terminal group is defined as subframe allocation information. A method by which the base station transmits the subframe allocation information to the terminal includes a method of broadcasting the subframe allocation information to all terminals in a cell, and a method of individually transmitting the subframe allocation information to related terminals. The terminal may receive the subframe allocation information and recognize a downlink subframe transmitted from the base station or an uplink subframe to be transmitted to the base station.

A method of transmitting subframe allocation information according to a first embodiment may include a method of broadcasting the subframe allocation information to all terminals in a cell. This method is a method of transmitting the subframe allocation information through broadcasting information (system information) of RRC in the 3GPP. A method of transmitting subframe allocation information according to a second embodiment may include a method of individually transmitting the subframe allocation information to related terminals. This method is a method of transmitting the subframe allocation information through a signaling radio bearer (SRB) of RRC in the 3GPP.

Here, an upper RRC layer relative to a MAC layer performs several control functions related to setup, change and release of lower layers in a terminal or a network. To support several RRC procedures, related RRC messages are exchanged between the terminal and the network.

Three RRC messages, such as an MIB message, an SIB1 message, and a system information (SI) message, are used to deliver system information. Here, the SI includes SI blocks (SIBs) each containing a set of functionally related parameters.

The base station may transmit one or a plurality of pieces of subframe allocation information to the terminal. Here, each piece of subframe allocation information indicates a subframe used by only a specific terminal or terminal group. According to the subframe allocation information, there may be terminals capable of receiving the subframe allocation information and terminals incapable of receiving the subframe allocation information. Among terminals, there may be terminals capable of receiving no subframe allocation information and terminals capable of receiving one or a plurality of pieces of subframe allocation information.

The terminal capable of receiving the subframe allocation information receives the subframe allocation information, and the terminal may use a subframe indicated by the subframe allocation information if the subframe allocation information is associated with the terminal. On the other hand, the terminal capable of receiving the subframe allocation information receives the subframe allocation information, and the terminal does not use a subframe indicated by the subframe allocation information if the subframe allocation information is not associated with the terminal.

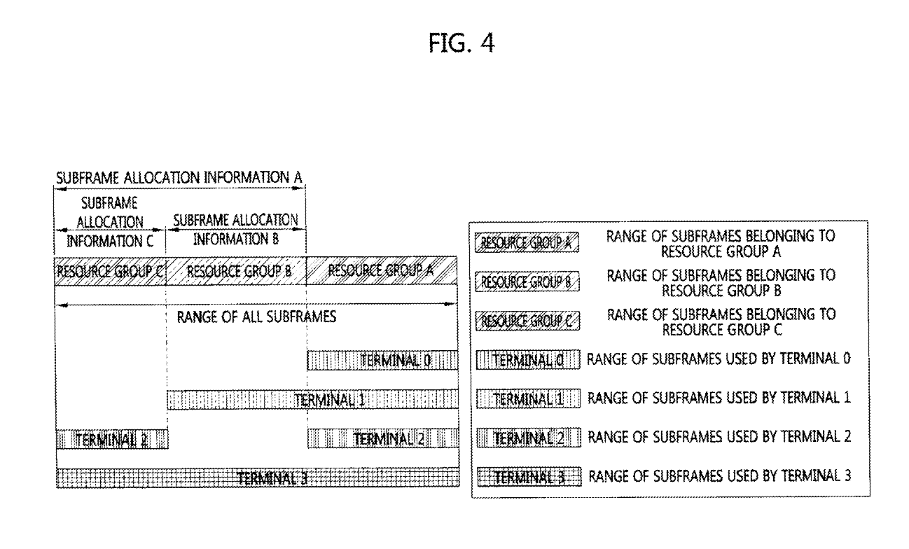

FIG. 4 is a conceptual diagram of a method of allocating radio resources according to another embodiment of the present invention.

In FIG. 4, all subframes are assumed to be divided into three resource groups. It is assumed that terminal 0 is an LTE terminal and does not receive MBMS, terminal 1 is an LTE-Advanced terminal and does not receive MBMS, terminal 2 is an LTE terminal and receives MBMS, and terminal 3 is an LTE-Advanced terminal and receives MBMS.

Here, it is assumed that terminal group 1 is a group of terminals that receive a nominal MBMS subframe, and resource allocation information for the terminals is allocation information A. It is also assumed that terminal group 2 is a group of LTE-Advanced terminals, and resource allocation information for the terminals is allocation information B. It is also assumed that terminal group 3 is a group of terminals that substantially receive MBMS data, and resource allocation information for the terminals is allocation information C.

Here, the nominal MBMS subframe refers to a multimedia broadcast single frequency network (MBSFN) subframe used for, for example, relaying, positioning, and the like. The MBSFN subframe was originally proposed for MBMS, but may be used for usages other than MBMS such as relay or positioning. Here, in only a system of a version next to LTE-Advanced, the MBSFN subframe may be used for usages other than MBMS such as relay and positioning. That is, only an LTE-Advanced terminal can receive the nominal MBMS subframe and use information related to services such as relay or positioning contained in the subframe. Art LTE terminal may receive the nominal MBMS subframe, but determines that data contained in the subframe is not associated with the LTE terminal, and does not use the data.

Operation of terminals will be described in greater detail with reference to FIG. 4.

The base station can transmit subframe allocation information A so that subframe allocation information A can be received by both the LTE terminal and the LTE-Advanced terminal. Further, the base station may transmit subframe allocation information B so that subframe allocation information B can be received by only the LTE-Advanced terminal. Further, the base station may transmit subframe allocation information C so that subframe allocation information C can be received by only a terminal receiving MBMS.

Since terminal 0 is an LTE terminal and does not receive MBMS, terminal 0 can receive only subframe allocation information A. Terminal 0 receives subframe allocation information A, but determines that subframes indicated by subframe allocation information A are not associated with terminal 0 and does not use the subframes. Accordingly, the base station and terminal 0 are allowed to use subframes other than the subframes indicated by subframe allocation information A, i.e., only subframes of resource group A, among all subframes.

Terminal 1 can receive subframe allocation information A and subframe allocation information B. While terminal 1 does not receive MBMS, terminal 1 determines that the subframes indicated by subframe allocation information A are associated with terminal 1 and does not exclude the subframes, unlike terminal 0. Terminal 1 does not exclude the subframes indicated by subframe allocation information A, but does not use all the subframes indicated by subframe allocation information A. Further, terminal 1 determines that subframes indicated by subframe allocation information B are associated with terminal 1, and uses the subframes. Accordingly, the base station and terminal 1 are allowed to use only subframes of resource group A and subframes of resource group B among all subframes.

Terminal 2 can receive subframe allocation information A and subframe allocation information C. Terminal 2 determines that the subframes indicated by subframe allocation information A are associated with terminal 2 and does not exclude the subframes. Terminal 2 does not exclude the subframes indicated by subframe allocation information A, but does not use ail the subframes indicated by subframe allocation information A. Further, terminal 2 determines that subframes indicated by subframe allocation information C are associated with terminal 2, and uses the subframes. Accordingly, the base station and terminal 2 are allowed to use the subframes of resource group A and subframes of the resource group C among ail the subframes.

Terminal 3 can receive subframe allocation information A, subframe allocation information B, and subframe allocation information C. Terminal 3 determines that the subframes indicated by subframe allocation information A are associated with terminal 3 and does not exclude the subframes. Terminal 3 does not exclude the subframes indicated by subframe allocation information A, but does not use all the subframes indicated by subframe allocation information A. Further, terminal 3 determines that the subframes indicated by subframe allocation information B are associated with terminal 3, and uses the subframes. Further, terminal 3 determines that the subframes indicated by subframe allocation information C are associated with terminal 3, and uses the subframes. Accordingly, the base station and terminal 3 are allowed to use the subframes of resource group A, the subframes of resource group B, and the subframes of the resource group C among all subframes.

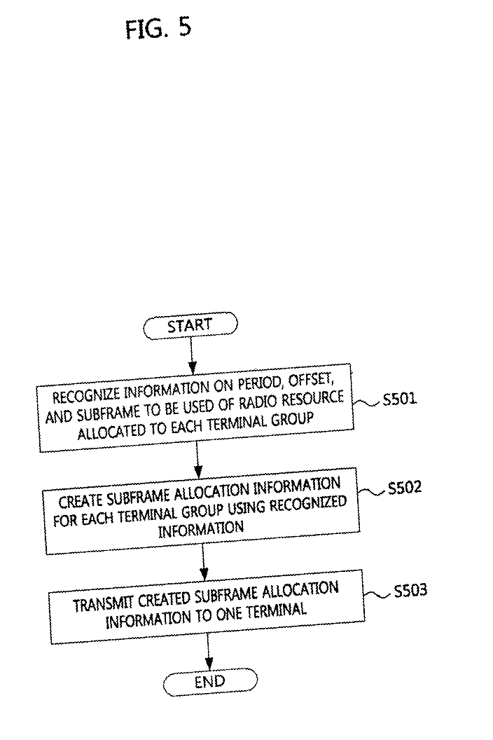

FIG. 5 is a flowchart of a method of allocating radio resources according to a preferred embodiment of the present invention.

Referring to FIG. 5, in the method of allocating radio resources according to the present invention, first, information on a period, an offset, and a subframe to be used regarding radio resources allocated to each terminal group is recognized (S501). Here, each terminal group includes at least one terminal that shares a feature. Then, subframe allocation information is created for each terminal group using the recognized information (S502). Last, the created subframe allocation information is transmitted to the at least one terminal (S503).

While the invention has been shown and described with reference to certain exemplary embodiments thereof, it will be understood by those skilled in the art that various changes in form and details may be made therein without departing from the spirit and scope of the invention as defined by the appended claims.

1. An apparatus for allocating radio resources to at least one terminal in a wireless communication network in which the radio resources use a frame structure divided in terms of time and having a certain period, the apparatus comprising:
a control unit for recognizing information on a period, an offset, and subframes to be used regarding radio resources allocated to a terminal group consisting of at least one terminal sharing a feature, and forming subframe allocation information for each terminal group using the information; and
a wireless transmission unit for transmitting the formed subframe allocation information to the at least one terminal.

2. The apparatus of claim 1, wherein the information on the subframes to be used includes a first subframe indicated by each configuration, and the number of continuously used subframes in each configuration.

3. The apparatus of claim 2, wherein the first subframe indicated by each configuration is calculated using at least one of the number of subframes constituting one frame, a frame index, a subframe index, and a period of the configuration.

4. The apparatus of claim 3, wherein subframes indicated by a configuration i are defined as allocation information for each terminal group by the following equation:
(n_{ƒ}×N_{sƒ}+n_{sƒ})modT_{sƒ,i} ∈{D_{sƒ,i}, (D_{sƒ,i}+1), . . . , (D_{sƒ,i}+N_{consc,i}−1)}
where N_{sƒ} denotes the number of subframes constituting one frame, n_{ƒ} denotes a frame index, n_{sƒ} denotes a subframe index, T_{sƒ,i} denotes a period of configuration i, D_{sƒ,i} denotes an offset of configuration i, N_{consc,i} denotes the number of continuously used subframes of configuration i, and “mod” denotes a modulo operator.

5. The apparatus of claim 1, wherein the information on the subframes to be used is bitmap information for available subframes in at least one frame in one period.

6. The apparatus of claim 5, wherein the number of bits constituting the bitmap is calculated by multiplying the number of available subframes in one frame and the number of frames indicated by the bitmap.

7. The apparatus of claim 5, wherein an offset D_{f,i} of configuration i is defined as allocation information for each terminal group by the following equation:
n_{ƒ}modT_{ƒ,i}=D_{ƒ, i}
where n_{ƒ} denotes a frame index, T_{ƒ, i} denotes a period of configuration i, D_{ƒ, i} denotes an offset of configuration i, and “mod” denotes a modulo operator.

8. The apparatus of claim 1, wherein the subframe allocation information is transmitted to all terminals in a cell by broadcast using broadcast information in a radio resource control (RRC) message.

9. The apparatus of claim 1, wherein the subframe allocation information is individually transmitted to at least one terminal related to the subframe allocation information through a signaling radio bearer in an RRC message.

10. A method of allocating radio resources to at least one terminal in a wireless communication network in which the radio resources use a frame structure divided in terms of time and having a certain period, the method comprising:
recognizing information on a period, an offset, and subframes to be used regarding radio resources allocated to a terminal group consisting of at least one terminal sharing a feature, and forming subframe allocation information for each terminal group using the information; and
transmitting the formed subframe allocation information to the at least one terminal.

11. The method of claim 10, wherein the information on the subframes to be used includes a first subframe indicated by each configuration and the number of continuously used subframes in each configuration, the first subframe and the number of continuously used subframes being allocation information for each terminal group.

12. The method of claim 11, wherein the first subframe indicated by each configuration is calculated using at least one of the number of subframes constituting one frame, a frame index, a subframe index, and a period of the configuration.

13. The method of claim 10, wherein the information on the subframes to be used is bitmap information for available subframes in at least one frame in one period.

14. The method of claim 13, wherein the number of bits constituting the bitmap is calculated by multiplying the number of available subframes in one frame and the number of frames indicated by the bitmap.

15. The method of claim 10, wherein the terminal group consisting of at least one terminal sharing a feature includes at least one of a group of terminals that receive a nominal MBMS subframe, an LTE-Advanced terminal group, and a group of terminals that substantially receive MBMS data.
